(19) United States
(12) Patent Application Publication
(10) Pub. No.: US 2007/0076079 A1
(43) Pub. Date: Apr. 5, 2007

(54) Method for forming a pattern and liquid ejection apparatus

(75) Inventor: Hirotsuna Miura, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/542,559

(22) Filed: Oct. 3, 2006

(30) Foreign Application Priority Data
Oct. 4, 2005 (JP) 2005-291555
Sep. 7, 2006 (JP) 2006-243068

(51) Int. Cl. B41J 2/01

(52) U.S. Cl. 347/102

(57) ABSTRACT

A light blocking member is formed of a light absorbing material and arranged across a straight line extending between a radiating position on a substrate onto which a laser beam is radiated and a nozzle. The light blocking member is formed by a rectangular frame projecting from a nozzle surface of the nozzle plate toward the substrate. The light blocking member is arranged so as to encompass the outer circumference of the nozzle. The blocking height of the light blocking member is set to a value equal to the sum of the blocking width and the nozzle diameter. The light blocking member blocks reflected diffuse light that has been reflected and diffused at the radiating position.

### CROSS-REFERENCE TO RELATED APPLICATIONS

This application is based upon and claims the benefit of priority from prior Japanese Patent Application Nos. 2005-291555 filed on Oct. 4, 2005, and 2006-243068 filed on Sep. 7, 2006, the entire contents of which are incorporated herein by reference.

### BACKGROUND

1. Technical Field

The present invention relates to a method for forming a pattern and a liquid ejection apparatus.

2. Related Art

Typically, a display such as a liquid crystal display or an electroluminescence display includes a substrate that displays an image. The substrate has an identification code (for example, a two-dimensional code) representing encoded information including the site of production and the product number. The identification code is formed by structures (dots formed by colored thin films or recesses) that reproduce the identification code. The structures are provided in multiple dot formation areas (data cells) in accordance with a prescribed pattern.

As a method for forming the identification code, a laser sputtering method and a waterjet method have been described in JP-A-11-77340 and JP-A-2003-127537. In the laser sputtering method, films forming a code pattern are provided through sputtering. The waterjet method involves ejection of water containing abrasive material onto a substrate for marking a code pattern on the substrate.

However, to form the code pattern in a predetermined size by the laser sputtering method, the interval between a metal foil and a substrate must be adjusted to several or several tens of micrometers. The corresponding surfaces of the substrate and the metal foil thus must be extremely flat and the interval between the substrate and the metal foil must be adjusted with accuracy of the order of micrometer. Therefore, the laser sputtering method is applicable only to certain types of substrates, making it difficult to form identification codes in a wider range of substrates. In the waterjet method, water or dust or abrasive may splash onto and contaminate a substrate, when forming a code pattern on the substrate.

To solve these problems, an inkjet method has been focused on as an alternative method for forming an identification code. In the inkjet method, droplets of liquid containing metal particles are ejected from a nozzle. The droplets are then dried and thus form dots. The inkjet method is applicable to a wider variety of substrates and prevents contamination of the substrates caused by formation of the identification codes.

However, when drying droplets on a substrate, the inkjet method may have the following problem caused by the surface condition of the substrate or the surface tension of each droplet. Specifically, after having been received by the surface of the substrate, the droplet may spread on the substrate surface as the time elapses. Therefore, if the time necessary for drying the droplet exceeds a predetermined level (for example, 100 milliseconds), the droplet may spread beyond the corresponding data cell and reaches an adjacent data cell. This may lead to erroneous formation of the code pattern.

This problem may be avoided by employing a method illustrated in FIG. 10. In the method, a laser beam L is radiated onto a substrate 102 located immediately below a liquid ejection head 101. Therefore, when a droplet Fb on the substrate 102 enters a radiation range of the laser beam L, the droplet Fb is instantly dried by the laser beam L. However, reflection light Lr and diffused light Ld are radiated from the droplet Fb and the substrate 102 onto the vicinity of an ejection port 103 of the liquid ejection head 101. This dries and bakes the liquid F in the ejection port 103, solidifying the liquid F. As a result, the ejection path of the droplet Fb may become offset or clogging of the ejection port 103 may occur.

### SUMMARY

Accordingly, it is an objective of the present invention to provide a method for forming a pattern and a liquid ejection apparatus that prevents an ejection path of a droplet from becoming offset and an ejection port from being clogged, thereby enhancing controllability of the formation of the pattern.

To achieve the foregoing objectives and in accordance with one aspect of the present invention, a method for forming a pattern by ejecting droplets of a liquid containing a pattern forming material from ejection ports defined in a liquid ejection head onto a substrate, moving the substrate to a radiating position of a laser beam, and radiating the laser beam onto the droplets on the substrate when the droplets reach the radiating position is provided. The method includes: blocking the laser beam that has been reflected by the substrate toward the ejection ports by a light blocking member, the light blocking member being provided across a straight line extending between the radiating position and any of the ejection ports, thereby preventing the laser beam from reaching the ejection ports.

In accordance with another aspect of the present invention, a liquid ejection apparatus having a liquid ejection head, a laser radiation device, and a movement device is provided. An ejection port is defined in the liquid ejection head to face a substrate. A droplet of a liquid is ejected from the ejection port onto the substrate. The laser radiation device radiates a laser beam onto the substrate. The movement device moves the substrate relative to the laser radiation device to send the droplet on the substrate to a radiating position of the laser beam. The apparatus includes a light blocking member. The light blocking member blocks the laser beam that has been reflected by the substrate toward the ejection port to prevent the laser beam from reaching the ejection port. The light blocking member is arranged across a straight line extending between the radiating position and the ejection port.

In accordance with yet another aspect of the present invention, a liquid ejection apparatus having a liquid ejection head, a laser radiation device, and a movement device is provided. A plurality of ejection ports are defined in the liquid ejection head to face a substrate. A droplet of a liquid is ejected from each of the ejection ports onto the substrate. The laser radiation device radiates a laser beam onto the substrate. The movement device moves the substrate relative to the laser radiation device to send each of the droplets on the substrate to a radiating position of the laser beam. The apparatus includes a light blocking member. The light blocking member blocks the laser beam that has been reflected by the substrate toward the corresponding ejection port to prevent the laser beam from reaching the ejection ports. The light blocking member is arranged across a straight line extending between each of the radiating positions and the corresponding one of the ejection ports. The ejection ports are aligned in a single line on a surface of the substrate. The light blocking member extends in the alignment direction of the ejection ports and encompassing all of the ejection ports.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a plan view showing a liquid crystal display having a pattern formed by a pattern forming method according to an embodiment of the present invention;

FIG. 2 is a perspective view schematically showing a liquid ejection apparatus according to the embodiment of FIG. 1;

FIG. 3 is a perspective view schematically showing a liquid ejection head and a laser head;

FIG. 4 is a cross-sectional view schematically showing the liquid ejection head and the laser head;

FIG. 5 is a block diagram representing the electric circuit of the liquid ejection apparatus;

FIG. 6 is a cross-sectional view schematically showing a liquid ejection head of a modification;

FIG. 7 is a cross-sectional view schematically showing a liquid ejection head of another modification;

FIG. 8 is a cross-sectional view schematically showing a liquid ejection head of another modification;

FIG. 9 is a cross-sectional view schematically showing a liquid ejection head of another modification; and

FIG. 10 is a cross-sectional view schematically showing a typical liquid ejection head and a typical laser head.

### DESCRIPTION OF EXEMPLARY EMBODIMENTS

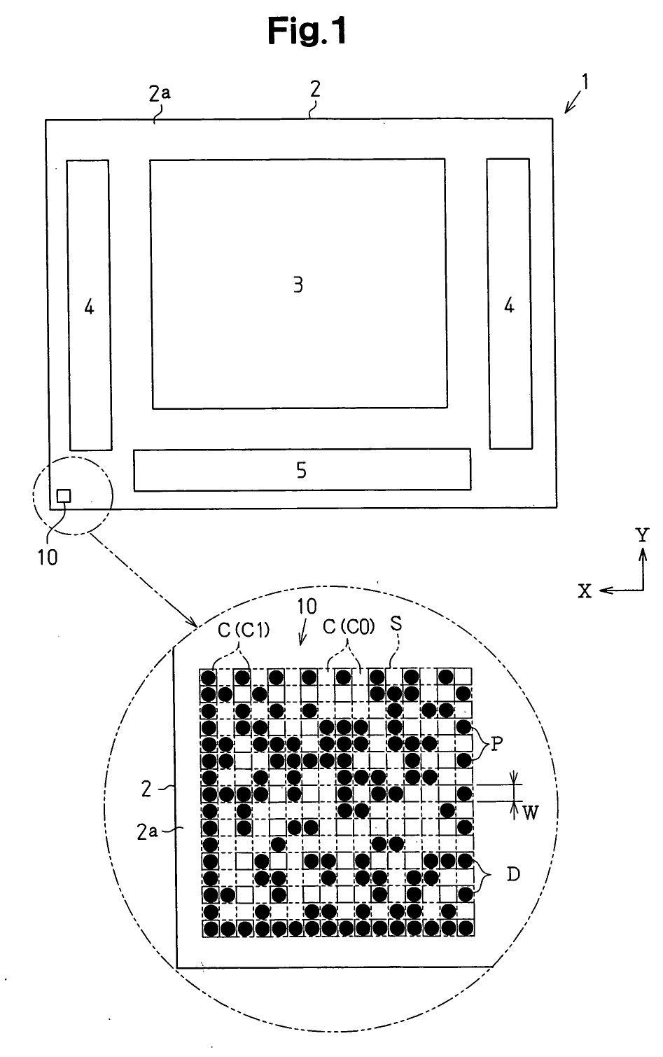

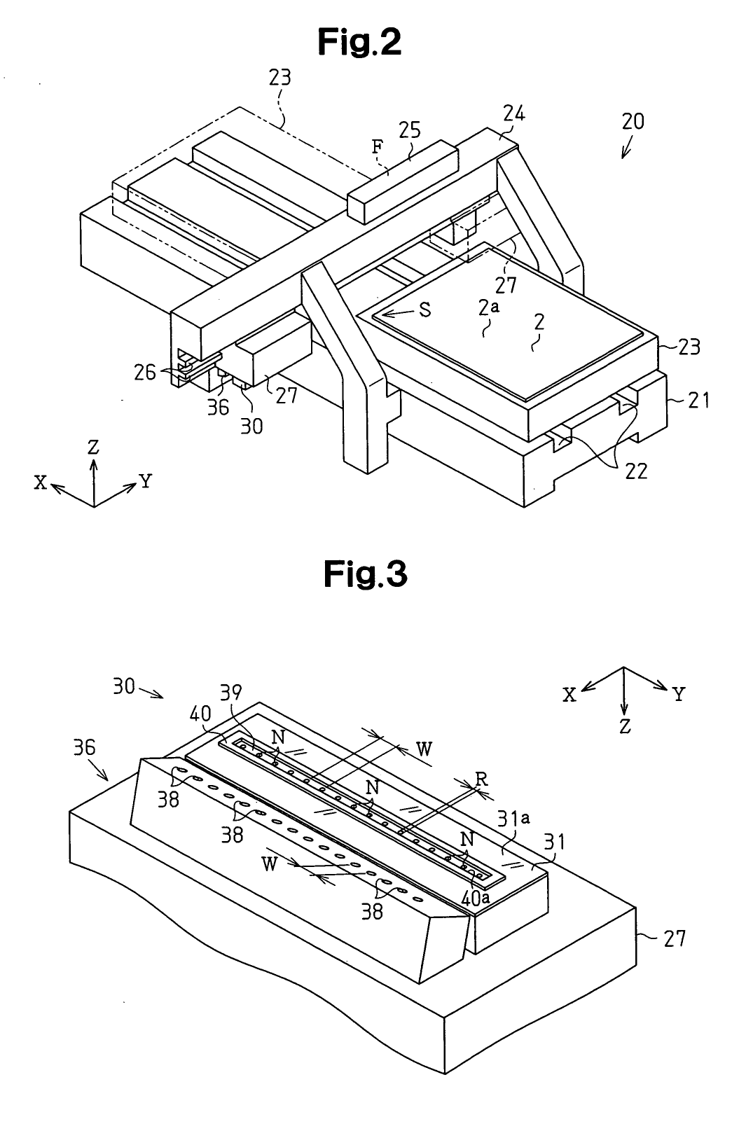

A liquid crystal display having an identification code formed by a method for forming a pattern according to the present invention will now be described with reference to FIGS. 1 to 5. In the following, direction X, direction Y, and direction Z will be defined as illustrated in FIG. 2.

As shown in FIG. 1, a liquid crystal display 1 has a rectangular glass substrate (hereinafter, refereed to as a substrate) 2. A rectangular display portion 3 is formed substantially at the center of a surface 2a of the substrate 2. Liquid crystal molecules are sealed in the display portion 3. A scanning line driver circuit 4 and a data line driver circuit 5 are provided outside the display portion 3. In the liquid crystal display 1, the orientation of the liquid crystal molecules is adjusted in correspondence with a scanning signal generated by the scanning line driver circuit 4 and a data signal produced by the data line driver circuit 5. In accordance with the orientation of the liquid crystal molecules, area light radiated by an illumination device (not shown) is modulated to display an image on the display portion 3 of the substrate 2.

An identification code 10 indicating the product number or the lot number of the liquid crystal display 1 is formed at the left corner of the surface 2a of the substrate 2. The identification code 10 is formed by a plurality of dots D and provided in a code formation area S in accordance with a prescribed pattern. The code formation area S includes 256 data cells, aligned by 16 lines and 16 rows. Each of the data cells C is defined by virtually dividing the code formation area S, which has a square shape of 1 mm×1 mm, into equally sized sections. The dots D are formed in selected ones of the data cells C, thus forming the identification code 10. In the following, each of the cells C in which the dot D is provided is referred to as a black cell C1, or a dot forming position. Each of the empty cells C is referred to as a blank cell C0. The center of each black cell C1 is referred to as an “ejection target position P” and the length of each of the sides of the data cell C is referred to as “cell width W”.

Each of the dots D is formed by ejecting a droplet Fb of liquid containing metal particles (for example, nickel or manganese particles) into the corresponding one of the data cells C (the black cells C1). The droplet Fb is then dried and baked in the cell C, thus providing the dot D. Alternatively, the dot D may be completed simply by drying the droplet Fb in the cell C through radiation of a laser beam.

A liquid ejection apparatus 20 for forming the identification code 10 will hereafter be explained.

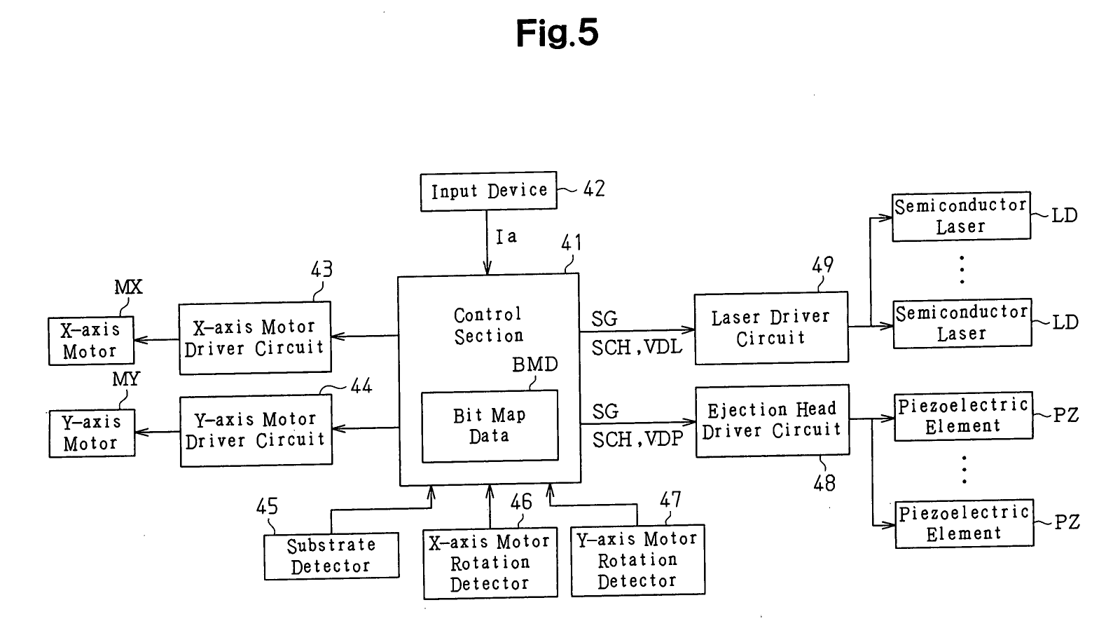

As shown in FIG. 2, the liquid ejection apparatus 20 has a parallelepiped base 21. A pair of guide grooves 22 are defined in the upper surface of the base 21 and extend in direction X. A substrate stage 23, or a movement device, is mounted on the base 21 and operably connected to an X-axis motor MX (see FIG. 5). When the X-axis motor MX runs, the substrate stage 23 moves in direction X or the direction opposite to direction X along the guide grooves 22. A suction type chuck mechanism (not shown) is provided on the upper surface of the substrate stage 23. The chuck mechanism operates to position and fix the substrate 2 on the substrate stage 23 at a predetermined position, with the surface 2a (the code formation area S) facing upward.

A gate-like guide member 24 is secured to opposing sides of the base 21. A reservoir tank 25 retaining liquid F is mounted on the guide member 24. A pair of guide rails 26 extending along direction Y are provided in a lower portion of the guide member 24 and extend in direction Y. A carriage 27 is movably supported by the guide rails 26. The carriage 27 is operably connected to a Y-axis motor MY (see FIG. 5). The carriage 27 moves in direction Y or the direction opposite to direction Y along the guide rails 26.

A liquid ejection head (hereinafter, referred to as an ejection head) 30 ejecting liquid is secured to the lower surface of the carriage 27. FIG. 3 is a perspective view showing the ejection head 30 as viewed from the side corresponding to the substrate 2. As illustrated in FIG. 3, the ejection head 30 includes a nozzle plate 31 formed on the surface (the top surface as viewed in FIG. 3) of the ejection head 30 opposed to the substrate 2. The nozzle plate 31 is formed by a plate member formed of stainless steel. The pitch of the nozzles N is set to a value equal to the pitch of the ejection target positions P (the cell width W of FIG. 1).

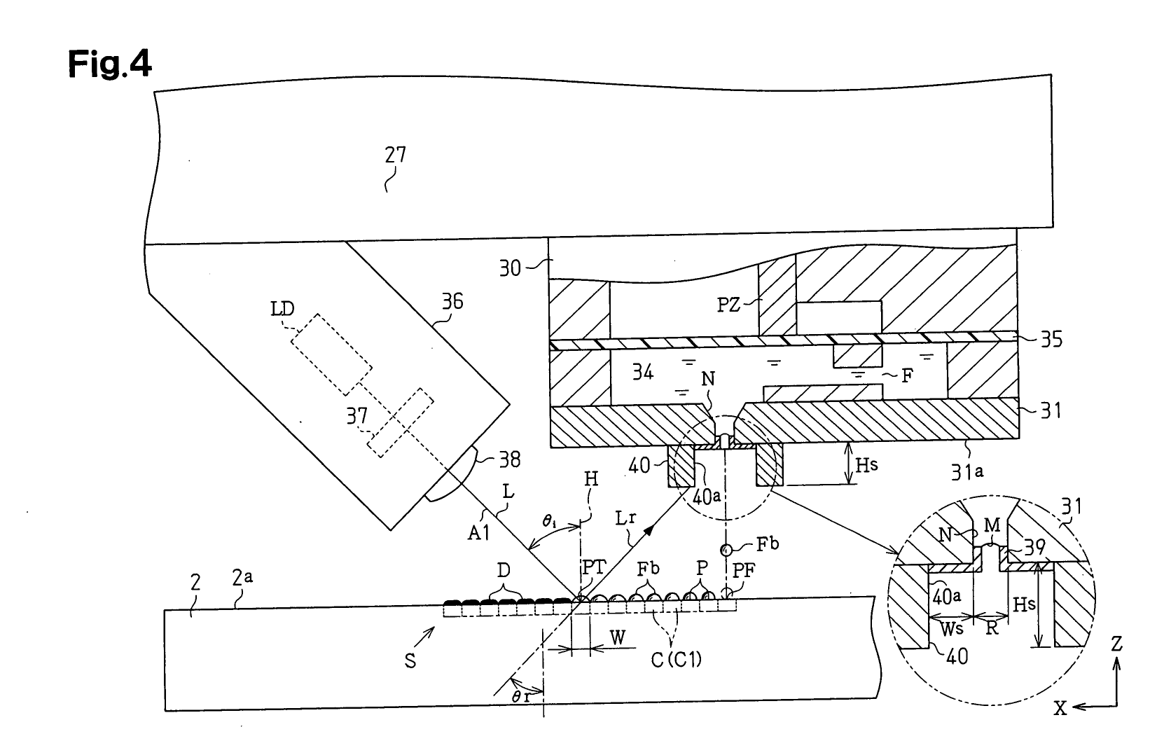

As shown in FIG. 4, a nozzle surface 31a of the nozzle plate 31 is arranged parallel with the surface 2a of the substrate 2. Each of the nozzles N is a circular bore that extends in a direction perpendicular to the surface 2a of the substrate 2 and through the nozzle plate 31. The inner diameter of each of the nozzles N is set to, for example, 30 μm. In the following, the position of the substrate 2 opposed to each of the nozzles N is referred to as a “droplet receiving position PF”.

Cavities 34 communicating with the reservoir tank 25 are defined in the ejection head 30. The liquid F in the reservoir tank 25 is supplied to the nozzles N through the corresponding cavities 34. An oscillation plate 35, which oscillates in an upward-downward direction, is provided above each of the cavities 34 in the ejection head 30. Through oscillation of each oscillation plate 35, the volume of the corresponding cavity 34 is increased or decreased. A plurality of piezoelectric elements PZ are arranged on the oscillation plates 35 at positions corresponding to the nozzles N. When any one of the piezoelectric elements PZ repeatedly contracts and extends in an upward-downward direction, the corresponding one of the oscillation plates 35 oscillates in the upward-downward direction.

Specifically, the piezoelectric element PZ contracts and extends when the corresponding black cell C1 (ejection target position P) coincides with the receiving position PF through transportation of the substrate stage 23 in direction X. This increases and decreases the volume of the corresponding cavity 34, thus oscillating the meniscus M. Thus, a predetermined amount of the liquid F is ejected from the corresponding nozzle N as a droplet Fb. The droplet Fb then reaches an ejection target position P (a receiving position PF) defined on the substrate 2 that is located immediately below the nozzle N. As the time elapses, the droplet Fb spreads wet at the ejection target position P and develops to a dry size (the cell width W). The center of the droplet Fb (the ejection target position P) when the outer diameter of the droplet Fb becomes equal to the cell width W will be referred to as a “radiating position PT”.

As illustrated in FIGS. 3 and 4, a laser head 36, or a laser radiation device, including semiconductor lasers LD is provided near the ejection head 30. The wavelength range of a laser beam L radiated by each of the semiconductor lasers LD corresponds to the absorption wavelength of the liquid F (dispersion medium and metal particles). Each semiconductor laser LD has an optical system having a collimator 37 and a collective lens 38. The collimator 37 collimates the laser beam L of the semiconductor laser LD to a parallel flux of light and sends the flux to the collective lens 38. The collective lens 38 converges the laser beam L, which has passed through the collimator 37, and guides the laser beam L to the surface 2a of the substrate 2. In the illustrated embodiment, the incident angle θi between the optical axis A1 of the optical system and a normal line H perpendicular to the substrate 2 is set to a value greater than 45 degrees. The reflection angle (the reflection/diffusion angle θr) of a reflected diffuse light Lr from the radiating position PT is set to a value greater than 45 degrees.

When the droplet Fb, which has reached the droplet receiving position PF, passes the radiating position PT, the corresponding semiconductor laser LD radiates the laser beam L. The laser beam L evaporates the dispersion medium from the droplet Fb, suppressing wet spreading of the droplet Fb. Meanwhile, the metal particles in the droplet Fb are baked through continuous radiation of the laser beam L. As a result, a semispherical dot D having an outer diameter equal to the cell width W is formed on the surface 2a of the substrate 2.

When a dot D is formed, the laser beam L that has been radiated onto the radiating position PT is partially reflected and diffused by the substrate 2 and the droplet Fb toward the ejection head 30 (the nozzle N), generating the reflected diffuse light Lr. A most part of the reflected diffuse light Lr is formed by the laser beam L that has been specularly reflected by the surface 2a of the substrate 2 and the surface of the droplet Fb. Thus, the reflected diffused light Lr is reflected and diffused toward the nozzle N at an angle equal to the incident angle θi of the laser beam L. In other words, the reflection/diffusion angle θr of the reflected diffused light Lr is equal to the incident angle θi of the laser beam L at the radiating position PT.

A portion of the inner peripheral surface of each nozzle N and a portion of the nozzle surface 31a around the nozzles N are covered by a liquid repellent film 39 with a thickness of several hundreds of nanometers. The liquid repellent film 39 is transmissible to the laser beam L and formed of silicone resin or fluorine resin. The liquid repellent film 39 repels the liquid F and stabilizes the interface (the meniscus M) between the liquid F and the air in each of the nozzles N. In the illustrated embodiment, the liquid repellent film 39 is formed directly on the nozzle plate 31. However, a bonding layer with a thickness of several nanometers formed of, for example, a silane coupling agent, may be provided between the nozzle plate 31 and the liquid repellent film 39. This enhances bonding performance between the nozzle plate 31 and the liquid repellent film 39.

A light blocking member 40 is provided on the nozzle surface 31a in such a manner as to encompass the outer circumferences of the nozzles N and the liquid repellent film 39. The light blocking member 40 is formed by a rectangular frame (a projection) projecting downward from the nozzle surface 31a. The light blocking member 40 extends along the outer ends of the liquid repellent film 39. The light blocking member 40 is formed of material that absorbs the laser beam L and provided in such a manner as to block a straight line extending between each of the radiating positions PT and the corresponding one of the nozzles N. As the distance (the blocking width Ws) between an inner wall surface 40a of the light blocking member 40 located forward in direction X and the nozzles N becomes smaller or the height (the blocking height Hs) of the inner wall surface 40a becomes greater, the blocking range of the reflected diffused light Lr proceeding toward the nozzles N by the light blocking member 40 becomes greater.

More specifically, the light blocking member 40 blocks and absorbs the reflected diffused light Lr that has been reflected and diffused at the reflection/diffusion angle θr and satisfies the expression: Arctan((Ws+R)/Hs)<θr. R represents the diameter of each nozzle N. A most part of the reflected diffused light Lr has been reflected and diffused at the reflection diffused angle θr equal to the incident angle θi of the laser beam L. Therefore, the light blocking member 40 blocks and absorbs the reflected diffused light Lr from the laser beam L that has been radiated at the incident angle θi of the laser beam L satisfying the expression: Arctan((Ws +R)/Hs) < θi.

In the illustrated embodiment, the blocking width Ws is set to 100 μm and the blocking height Hs is set to a value equal to the sum of the blocking width Ws and the nozzle diameter R, or 130 μm. Therefore, the light blocking member 40 blocks the reflected diffused light Lr that has been reflected and diffused at the reflection/diffusion angle θr and satisfies the expression: Arctan((Ws+R)/Hs)=45 degrees<θr. As has been described, the incident angle θi between the optical axis A1 of the optical system and the normal line H of the substrate 2 is set to a value greater than 45 degrees. The light blocking member 40 thus blocks and absorbs the reflection diffused light Lr that has been reflected and diffused from the radiating positions PT toward the nozzles N.

Since the reflected diffused light Lr is blocked by the light blocking member 40, the viscosity of the liquid F in the nozzles N is prevented from increasing, thus suppressing solidification of the liquid F. Also, damages to the liquid repellent film 39 by the reflected diffused light Lr are prevented. Further, the light blocking member 40, which has a cylindrical shape, encompasses the outer circumferences of the nozzles N. Thus, even if multiple or diffuse reflection of the reflected diffused light Lr occurs between the surface 2a of the substrate 2 and the nozzle surface 31a, the light blocking member 40 blocks the reflected diffused light Lr, thus protecting the liquid F in the nozzles N from the reflected diffused light Lr. Accordingly, flowability of the liquid F and stability of the meniscus M of the liquid F are effectively maintained.

The reflected diffuse light Lr that has been absorbed by the light blocking member 40 may be converted into heat. The heat is escaped to the exterior through the nozzle plate 31 formed of stainless steel or the cavities 34 formed by components formed of Si. Further, the heat absorbed by the nozzle plate 31 may be escaped into the liquid F in the nozzles N. In this manner, the heat of the nozzle plate 31 lowers the viscosity of the liquid F, thus stabilizing ejection of the liquid F even when the liquid F exhibits a relatively high viscosity.

The electric circuit of the liquid ejection apparatus 20 will hereafter be explained with reference to FIG. 5.

As illustrated in FIG. 5, a control section 41 has a CPU, a RAM, and a ROM. The control section 41 performs procedures for moving the substrate stage 23 or operating the ejection head 30 or the laser head 36 in accordance with various data stored in the ROM and different control programs.

An input device 42 including a start switch and a stop switch is connected to the control section 41. The control section 41 receives manipulation signals and imaging date Ia representing the image of the identification code 10 from the input device 42. After having received the imaging data Ia from the input device 42, the control section 41 generates bit map data BMD, piezoelectric element drive voltage VDP, and laser drive voltage VDL. The bit map data BMD indicates whether to eject the droplets Fb onto the data cells C of the code formation area S. The piezoelectric element drive voltage VDL drives the piezoelectric elements PZ. The laser drive voltage VDL drives the semiconductor lasers LD.

An X-axis motor driver circuit 43 and a Y-axis motor driver circuit 44 are connected to the control section 41. The control section 41 sends a control signal to the X-axis motor driver circuit 43 for actuating the X-axis motor MX. The control section 41 sends a control signal to the Y-axis motor driver circuit 44 for actuating the Y-axis motor MY. In response to the control signal of the control section 41, the X-axis motor driver circuit 43 operates to rotate the X-axis motor MX in a forward or reverse direction, thus reciprocating the substrate stage 23. In response to the control signal of the control section 41, the Y-axis motor driver circuit 44 operates to rotate the Y-axis motor MY in a forward or reverse direction, thus reciprocating the carriage 27.

A substrate detector 45 capable of detecting an end of the substrate 2 is connected to the control section 41. In correspondence with a detection signal sent from the substrate detector 45, the control section 41 calculates the position of the substrate 2.

An X-axis motor rotation detector 46 and a Y-axis motor rotation detector 47 are connected to the control section 41. The X-axis motor rotation detector 46 and the Y-axis motor rotation detector 47 send detection signals to the control section 41. In correspondence with a detection signal sent from the X-axis motor rotation detector 46, the control section 41 calculates the movement direction and the movement amount of the substrate 2. When the center of one of the data cells C coincides with the receiving position PF, the control section 41 provides an ejection timing signal SG to the ejection head driver circuit 48 and the laser driver circuit 49. In correspondence with a detection signal sent from the Y-axis motor rotation detector 47, the control section 41 calculates the movement direction and the movement amount of the ejection head 30. As a result, the receiving positions PF corresponding to the nozzles N are arranged on the movement path of the ejection target positions P.

The ejection head driver circuit 48 is connected to the control section 41. The control section 41 sends an ejection timing signal SG synchronized with a prescribed clock signal and the piezoelectric element drive voltage VDP synchronized with a prescribed clock signal to the ejection head driver circuit 48. Further, the control section 41 generates head control signals SCH each synchronized with a prescribed reference clock in correspondence with the bit map data BMD. The head control signals SCH are then serially transmitted to the ejection head driver circuit 48. The ejection head driver circuit 48 converts the head control signals SCH of the control section 41 into parallel signals in correspondence with the piezoelectric elements PZ. In response to the ejection timing signal SG of the control section 41, the ejection head driver circuit 48 supplies the piezoelectric element drive voltage VDP to the piezoelectric elements PZ selected based on the head control signals SCH.

The laser driver circuit 49 is connected to the control section 41. The control section 41 outputs the ejection timing signal SG, the laser drive voltage VDL synchronized with a prescribed clock signal, and the head control signals SCH to the laser driver circuit 49. The laser driver circuit 49 converts the head control signals SCH to parallel signals in correspondence with the semiconductor lasers LD. After having received the ejection timing signal SG of the control section 41, the laser driver circuit 49 stands by for a predetermined time and then supplies the laser drive voltage VDL to the semiconductor lasers LD selected based on the head control signals SCH. In other words, the control section 41 operates the laser driver circuit 49 to radiate the laser beams L from the semiconductor lasers LD corresponding to the nozzles N from which the droplets Fb have been ejected.

In the following, the time from when the laser driver circuit 49 receives the ejection timing signal SG to when the laser drive voltage VDL is supplied will be referred to—as “standby time”. The standby time corresponds to the time from when a droplet Fb is received by the substrate 2 to when the droplet Fb reaches the radiating position PT. The laser driver circuit 49 stands by for a predetermined time after droplets Fb have been ejected from the corresponding nozzles N. The laser driver circuit 49 then operates to radiate laser beams L from the semiconductor lasers LD corresponding to the nozzles N from which the droplets Fb have been ejected when the outer diameter of the droplets Fb becomes equal to the cell width W.

First, as illustrated in FIG. 2, the substrate 2 is fixed to the substrate stage 23 with the surface 2a facing upward. In this state, the substrate 2 is located rearward from the guide member 24 in direction X.

Subsequently, the imaging data Ia is input to the control section 41 through manipulation of the input device 42. The control section 41 then produces the bit map data BMD based on the imaging data Ia. Further, the control section 41 generates the piezoelectric element drive voltage VDP and the laser drive voltage VDL, which drive the piezoelectric elements PZ and the semiconductor lasers LD, respectively.

Next, the control section 41 drives the Y-axis motor MY to set the carriage 27 (each of the nozzles N) at a predetermined position in such a manner that the ejection target positions P pass the corresponding receiving positions PF.

Once the carriage 27 is set at a predetermined position, the control section 41 actuates the X-axis motor MX to move the substrate stage 23 in direction X, thus starting transporting the substrate 2. The control section 41 determines whether the black cells Cl (the ejection target positions P) have reached the corresponding receiving positions PF in correspondence with detection signals sent from the substrate detector 45 and the X-axis motor rotation detector 46. When the black cells C1 move to the receiving positions PF, the control section 41 outputs the piezoelectric element drive voltage VDP and the head control signal SCH to the ejection head driver circuit 48. The control section 41 also supplies the laser drive voltage VDL and the head control signal SCH to the laser driver circuit 49. The control section 41 then stands by until the control section 41 must output the ejection timing signals SG to both of the ejection head-driver circuit 48 and the laser driver circuit 49.

When the black cells C1 (the ejection target positions P) of the first row reach the corresponding receiving positions PF, the control section 41 sends the ejection timing signals SG to the ejection head driver circuit 48 and the laser driver circuit 49.

After having sent the ejection timing signals SG, the control section 41 supplies the piezoelectric element drive voltage VDP to the piezoelectric elements PZ corresponding to the head control signal SCH via the ejection head driver circuit 48. This causes the nozzles N corresponding to the head control signal SCH to eject the droplets Fb simultaneously. The ejected droplet Fb reaches the receiving position PF (the ejection target position P) on the surface of the substrate 2.

After the standby time has elapsed since output of the ejection timing signal SG, the control section 41 supplies the laser drive voltage VDL to the semiconductor lasers LD corresponding to the head control signals SCH. This causes the semiconductor lasers LD selected based on the head control signals SCH to simultaneously radiate the laser beams L.

The laser beam L is radiated onto the droplet Fb when the droplet Fb passes the radiating position PT, or the outer diameter of the droplet Fb becomes equal to the cell width W. The laser beam L evaporates the dispersion medium from the droplet Fb and bakes the metal particles of the droplet Fb. As a result, a dot D having an outer diameter equal to the cell width W is provided on the surface 2a of the substrate 2.

When the dot D is being formed, the laser beam L radiated onto the radiating position PT is reflected and diffused toward the nozzles N of the ejection head 30, producing the reflection diffused light Lr. However, since the reflection/diffusion angle θr of a most part of the reflected diffuse light Lr is greater than 45 degrees, the reflected diffuse light Lr is blocked and absorbed by the light blocking member 40 without reaching the nozzles N. This protects the liquid F in the nozzles N from the reflected diffuse light Lr, effectively maintaining the flowability of the liquid F and the meniscus M of the liquid F. Thus, the traveling path of the droplet Fb is prevented from becoming offset or clogging of the nozzles N is avoided. Accordingly, the droplets Fb are continuously ejected from the liquid ejection head 30 in a stable manner.

Afterwards, each time the target ejection positions P reach the corresponding receiving positions PF, the control section simultaneously ejects the droplets Fb from the corresponding nozzles N in the above-described manner. When the outer diameter of each droplet Fb is equal to the cell width W, the laser head 36 is caused to simultaneously radiate the laser beams L onto the droplets Fb. In this manner, the dots D are formed in the code formation area S in accordance with a prescribed pattern, thus providing the identification code 10.

The presetn embodiment provides the following advantages.
(1) The light blocking member 40 is provided across the straight line extending between each radiating position PT and the corresponding nozzle N.

As the projection amount of the light blocking member 40 from the nozzle surface 31a becomes greater and the distance between the light blocking member 40 and the nozzles N becomes smaller, that is, as the blocking height Hs becomes greater and the blocking width Ws becomes smaller, the amount of the reflected diffuse light Lr proceeding from the substrate 2 toward the nozzles N blocked by the light blocking member 40 becomes greater. In this manner, the liquid F in the nozzles N and the liquid repellent film 39 are protected from the reflected diffuse light Lr. The reflected diffuse light Lr is thus prevented from causing drying and solidification of the liquid F in the nozzles N. Increase of the viscosity of the liquid F is also suppressed. Further, damages to the liquid repellent film 39 are avoided. This effectively maintains the flowability of the liquid F in the nozzles N and stability of the meniscus M of the liquid F in the nozzles N. Therefore, the traveling path of each droplet Fb is prevented from becoming offset and clogging of the nozzles N is avoided. This improves controllability for shaping the dots D.

(2) The light blocking member 40 is shaped like a rectangular frame in such a manner as to encompass the outer circumferences of the nozzles N. This allows the light blocking member 40 to block the reflected diffuse light Lr even if the reflected diffuse light Lr is multiply and diffusely reflected between the surface 2a of the substrate 2 and the nozzle surface 31a. The liquid F in the nozzles N is thus protected from the reflected diffuse light Lr, which prevents the viscosity of the liquid F in the nozzles N from increasing and suppresses solidification of the liquid F.

(3) The light blocking member 40 is formed of material that absorbs the laser beams L. The reflected diffuse light Lr is thus absorbed by the light blocking member 40 and prevented from being secondarily reflected. This suppresses multiple or diffuse reflection of the reflected diffuse light Lr between the surface 2a of the substrate 2 and the nozzle surface 31a. The viscosity of the liquid F in the nozzles N is thus prevented from increasing and solidification of the liquid F is avoided.

(4) The light blocking member 40 is provided in such a manner as to encompass the outer circumferences of all of the nozzles N aligned in direction Y. This structure reduces the number of the components compared to a case in which a separate light blocking member 40 is arranged for each of the nozzles N. Accordingly, through such a simple configuration, the traveling path of each droplet Fb is prevented from becoming offset and clogging of the nozzles N is avoided.

The present embodiment may be modified as shown below.

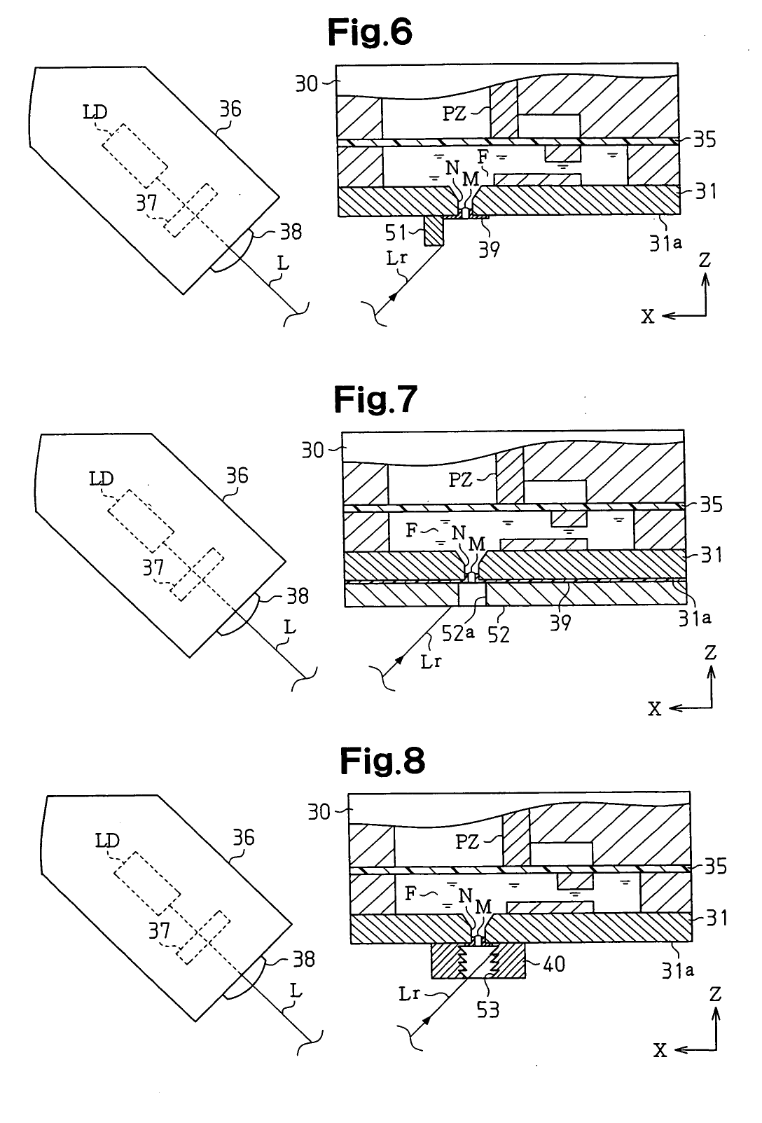

For example, as illustrated in FIG. 6, a light blocking member 51 may be arranged at a side of each nozzle N opposed to the laser head 36. In this case, through a further simplified configuration, the reflected diffuse light Lr from the radiating positions PT is blocked.

Alternatively, as shown in FIG. 7, a light blocking member 52 formed by a plate material arranged on the entire nozzle surface 31a may be employed. In this case, the light blocking member 52 has through holes 52a each of which extends along the extending line of the corresponding nozzle N. The light blocking member 52 may be mechanically or magnetically attachable to the nozzle surface 31a. The light blocking member 52 thus can be detached from the nozzle surface 31a, allowing easy cleansing of the nozzles N or the nozzle surface 31a and stable ejection of the droplets Fb.

Further, as illustrated in FIG. 8, a plurality of grooves 53 may be defined in inner walls of the light blocking member 40. In this case, the reflected diffuse light Lr from the substrate 2 enters the interiors of the grooves 53 and is multiply reflected in each of the grooves 53. The reflected diffuse light Lr is thus attenuated. In this manner, by changing the structure of the light blocking member 40, the light absorption performance of the light blocking member 40 is improved and the selective range of the material of the light blocking member 40 is enlarged.

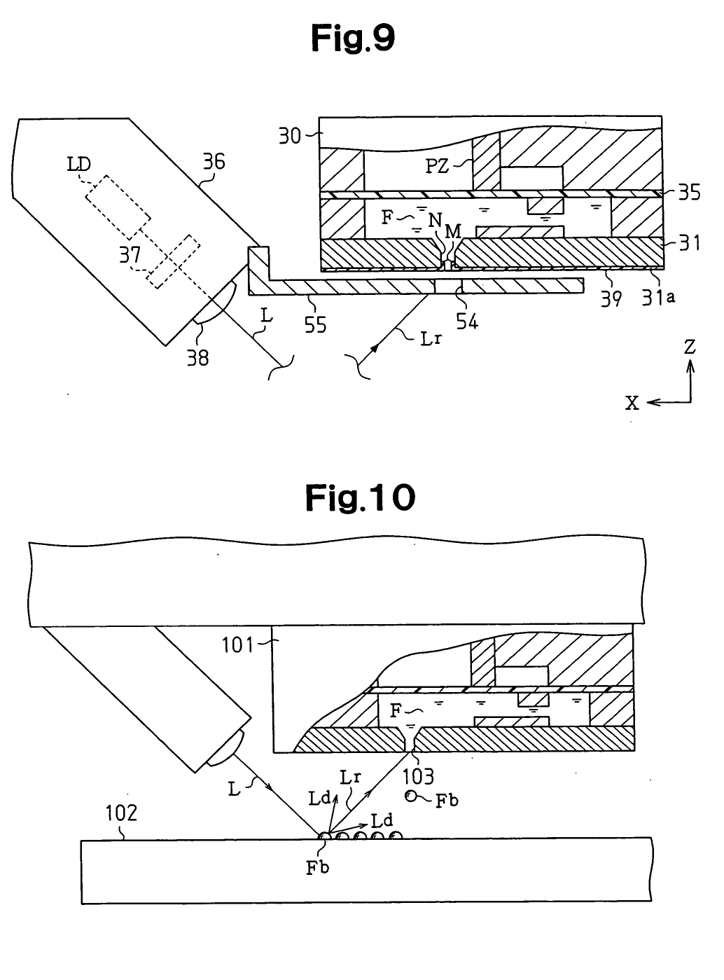

Further, for example, as shown in FIG. 9, as a light blocking member 55, a plate shaped similarly with the nozzle plate 31 may be employed. The light blocking member 55 is secured to the distal end of the laser head 36. A through hole 54 is defined in a portion of the light blocking member 55 opposed to each of the nozzles N. A droplet Fb passes through the through hole 54. The light blocking member 55 may be arranged at any suitable position as long as the light blocking member 55 is provided across a straight line extending between each radiating position PT and the corresponding nozzle N.

In the illustrated embodiment, the light blocking member 40 may be formed of a material that reflects light instead of the material that absorbs light. That is, the light blocking member 40 may be formed of any suitable material as long as the reflected diffuse light Lr is blocked by the light blocking member 40.

In the illustrated embodiment, the reflected diffuse light Lr may be reflected and diffused by the backside of the substrate 2 or the substrate stage 23.

In the illustrated embodiment, the droplets Fb may be caused to flow in a desired direction using energy generated by the laser beams L. Alternatively, by radiating the laser beam only to the outer peripheral end of each droplet Fb, the surface of the droplet Fb may be solidified (pinned) exclusively. In other words, the present invention may be applied to any other suitable method by which dots are formed through radiation of the laser beams L onto the droplets Fb.

In the illustrated embodiment, a carbon dioxide gas laser or a YAG laser may be used as a laser radiation source. That is, any suitable laser radiation source may be employed as long as the wavelength of the radiated laser beam L causes drying of the droplet Fb.

In the illustrated embodiment, instead of the semispherical dots D, oval dots or linear objects may be formed by the droplets Fb.

The present invention may be applied to a method for forming a pattern of an insulating film or metal wiring of a field effect type device (FED or SED). The field effect type device emits light from a fluorescent substance using electrons released from a flat electron release element. In other words, the present invention may be applied to any other suitable method for forming patterns by radiating laser beams B onto droplets Fb.

In the illustrated embodiment, the substrate 2 may be, for example, a silicone substrate, a flexible substrate, or a metal substrate.

1. A method for forming a pattern by ejecting droplets of a liquid containing a pattern forming material from ejection ports defined in a liquid ejection head onto a substrate, moving the substrate to a radiating position of a laser beam, and radiating the laser beam onto the droplets on the substrate when the droplets reach the radiating position, the method comprising:
blocking the laser beam that has been reflected by the substrate toward the ejection ports by a light blocking member, the light blocking member being provided across a straight line extending between the radiating position and any of the ejection ports, thereby preventing the laser beam from reaching the ejection ports.

2. A liquid ejection apparatus having a liquid ejection head, a laser radiation device, and a movement device, an ejection port being defined in the liquid ejection head to face a substrate, a droplet of a liquid being ejected from the ejection port onto the substrate, the laser radiation device radiating a laser beam onto the substrate, the movement device moving the substrate relative to the laser radiation device to send the droplet on the substrate to a radiating position of the laser beam, the apparatus comprising:
a light blocking member, the light blocking member blocking the laser beam that has been reflected by the substrate toward the ejection port to prevent the laser beam from reaching the ejection port,
wherein the light blocking member is arranged across a straight line extending between the radiating position and the ejection port.

3. The apparatus according to claim 2, wherein the light blocking member is provided on a surface of the liquid ejection head facing the substrate, the light blocking member projecting from the surface of the liquid ejection head toward the substrate.

4. The apparatus according to claim 3, wherein the light blocking member encompasses the outer circumference of the ejection port.

5. The apparatus according to claim 3, wherein the light blocking member encompasses the ejection port, and
wherein the following expression is satisfied: Arctan((Ws+R)/Hs)<θi, in which θi represents the incident angle of the laser beam with respect to the substrate, R represents the inner diameter of the ejection port, Ws represents the distance between the light blocking member and the ejection port, and Hs represents the projection height of the light blocking member.

6. The apparatus according to claim 2, wherein the light blocking member absorbs the laser beam.

7. The apparatus according to claim 6, wherein the light blocking member has a plurality of grooves, and wherein the laser beam that has been reflected by the substrate is multiply reflected by the inner sides of the grooves and thus attenuated.

8. A liquid ejection apparatus having a liquid ejection head, a laser radiation device, and a movement device, a plurality of ejection ports being defined in the liquid ejection head to face a substrate, a droplet of a liquid being ejected from each of the ejection ports onto the substrate, the laser radiation device radiating a laser beam onto the substrate, the movement device moving the substrate relative to the laser radiation device to send each of the droplets on the substrate to a radiating position of the laser beam, the apparatus comprising:
a light blocking member, the light blocking member blocking the laser beam that has been reflected by the substrate toward the corresponding ejection port to prevent the laser beam from reaching the ejection ports,
wherein the light blocking member is arranged across a straight line extending between each of the radiating positions and the corresponding one of the ejection ports, the ejection ports being aligned in a single line on a surface of the substrate, the light blocking member extending in the alignment direction of the ejection ports and encompassing all of the ejection ports.

9. The apparatus according to claim 3, wherein the light blocking member is detachable from a surface of the liquid ejection head.

10. The apparatus according to claim 9, wherein the light blocking member is magnetically secured to the surface of the liquid ejection head.
